(19) United States
(12) Patent Application Publication
(10) Pub. No.: US 2007/0267924 A1
(43) Pub. Date: Nov. 22, 2007

(54) VIBRATION DAMPING ROTOR ASSEMBLY FOR ROTATING MACHINERY

(75) Inventor: Stephen J. Dellinger, Houston, OH (US)

Correspondence Address: MICHAEL BEST & FRIEDRICH LLP, 100 E WISCONSIN AVENUE, Suite 3300, MILWAUKEE, WI, 53202, US

(73) Assignee: A. O. SMITH CORPORATION, Milwaukee, WI (US)

(21) Appl. No.: 11/748,836

(22) Filed: May 15, 2007

Related U.S. Application Data
(60) Provisional application No. 60/800,686, filed on May 16, 2006.

(51) Int. Cl. H02K 5/24; H02K 1/00

(52) U.S. Cl. 310/51; 310/216; 310/261

(57) ABSTRACT

A rotor for a motor having a rotor core length includes a shaft including a cylindrical portion and a shaft sleeve having a cylindrical opening. The shaft sleeve is coupled to the shaft such that the cylindrical opening and the cylindrical portion define an interference fit. A rotor sleeve extends the rotor core length and includes a cylindrical outer surface and an inner surface. The inner surface is spaced a non-zero distance from the shaft sleeve to define a space. A resilient material is disposed within the space and is bonded to the shaft sleeve and the rotor sleeve.

### RELATED APPLICATION DATA

This application claims benefit under 35 U.S.C. Section 119(e) of co-pending U.S. Provisional Application No. 60/800,686, filed May 16, 2006, which is fully incorporated herein by reference.

### BACKGROUND

The present invention relates to a rotor for an electric machine. More particularly, the invention relates to an electric machine that includes a rotor core having a resilient member that provides damping.

Electric machines such as generators and motors generally include a rotor disposed at least partially within a stator. The stator and rotor include magnets or energized coils that produce magnetic fields. The magnetic fields interact to produce the desired rotation (i.e., speed and direction) of the rotor.

Some rotors operate at varying speeds as may be required by the particular application. Some of these rotors may produce undesirable vibration at certain speeds (e.g., low speed operation). The vibration can produce additional wear on the component attached to the motor and as such are generally undesirable.

### SUMMARY

The invention provides a rotor core for an electric machine, such as a motor, that includes a resilient member that provides rotor damping to reduce motor noise. The core includes a first sleeve and a second sleeve that substantially define an annular space. A resilient material is positioned in the annular space to bond the first sleeve and the second sleeve to one another. The first sleeve includes a plurality of peaks and valleys that extend along the length of the sleeve to improve the connection between the first sleeve and the resilient material.

In one construction, the invention provides a rotor for a motor having a rotor core length. The rotor includes a shaft including a cylindrical portion and a shaft sleeve having a cylindrical opening. The shaft sleeve is coupled to the shaft such that the cylindrical opening and the cylindrical portion define an interference fit. A rotor sleeve extends the rotor core length and includes a cylindrical outer surface and an inner surface. The inner surface is spaced a non-zero distance from the shaft sleeve to define a space. A resilient material is disposed within the space and is bonded to the shaft sleeve and the rotor sleeve.

In another construction, the invention provides a rotor for a motor having a rotor core length. The rotor includes a shaft including a cylindrical portion and a shaft sleeve having a cylindrical opening and an exterior surface that includes a plurality of peaks and valleys. The shaft sleeve is coupled to the cylindrical portion. A rotor sleeve has a cylindrical outer surface and an inner surface. The inner surface is spaced a non-zero distance from the shaft sleeve to define a space. The rotor sleeve extends the core length and a resilient material is disposed within the space and bonded to the shaft sleeve and the rotor sleeve.

In yet another construction, the invention provides a rotor for a motor having a rotor core length. The rotor includes a shaft including a cylindrical portion that defines a rotational axis. A shaft sleeve is coupled to the shaft and has a first inner surface and a first outer surface. The first inner surface has a circular cross section in a plane normal to the rotational axis and the first outer surface has a non-circular cross section in the plane. A rotor sleeve extends the rotor core length and includes a second outer surface and a second inner surface. The second outer surface has a circular cross section in the plane and the second inner surface has a non-circular cross section in the plane. The inner surface is spaced a non-zero distance from the shaft sleeve to define a space and a resilient material is disposed within the space and bonded to the first outer surface and the second inner surface.

### BRIEF DESCRIPTION OF THE DRAWINGS

FIG. 1 is a side schematic view of a motor including a rotor;

FIG. 2 is a section view of the rotor core of FIG. 1 taken along line 2-2 of FIG. 3;

FIG. 3 is a front view of the rotor core of FIG. 1;

FIG. 4 is a section view of a shaft sleeve of the rotor core of FIG. 1 taken along line 4-4 of FIG. 5;

FIG. 5 is a front view of the shaft sleeve of FIG. 4;

FIG. 6 is a section view of another rotor core taken along line 6-6 of FIG. 7;

FIG. 7 is a front view of the rotor core of FIG. 6;

FIG. 8 is a section view of another rotor core taken along line 8-8 of FIG. 9;

FIG. 9 is a front view of the rotor core of FIG. 8;

FIG. 10 is a front view of the shaft sleeve of the rotor core of FIG. 8;

FIG. 11 is an enlarged view of a peak of the inner surface of the rotor sleeve of the rotor core of FIG. 8;

FIG. 12 is a section view of the rotor core of FIG. 3 taken along line 2-2 of FIG. 3 and including a spacer; and

FIG. 13 is a section view of the rotor core of FIG. 3 taken along line 2-2 of FIG. 3 and including another spacer.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

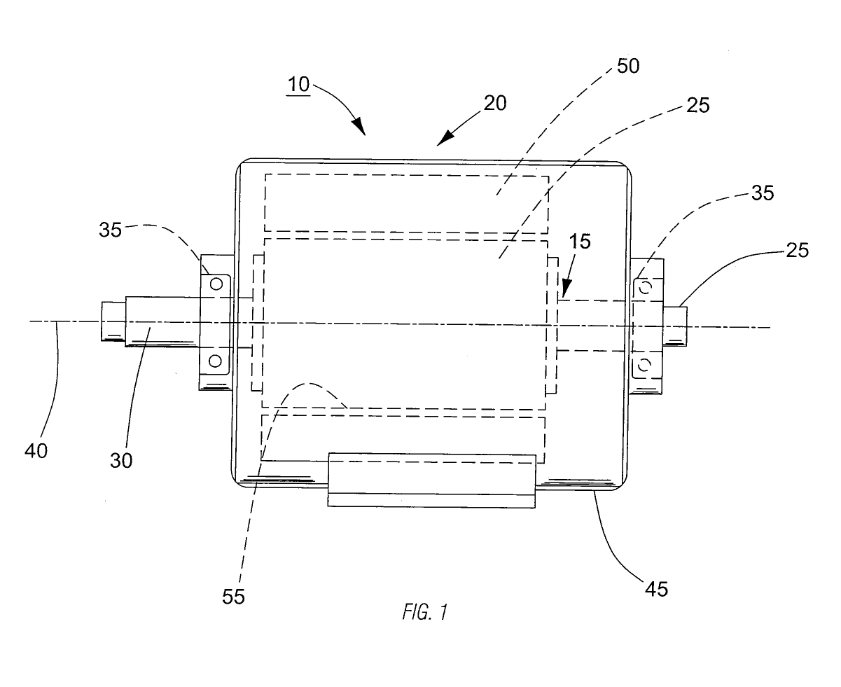

As schematically illustrated in FIG. 1, a motor 10 generally includes a rotor 15 disposed within a stator 20. The rotor 15 includes a rotor core 25 and a preferably solid shaft 30 that extends from one or both ends of the rotor core 25 to provide support points and to provide a convenient shaft power take off point. Generally, two or more bearings 35 engage the rotor shaft 30 and support the rotor 15 such that it rotates about a rotational axis 40. The stator 20 generally includes a housing 45 that supports a stator core 50. The stator core 50 defines a substantially cylindrical aperture 55 that is centered on the rotational axis 40. When the rotor 15 is in its operating position relative to the stator 20, the rotor core 25 is generally centered within the aperture 55 such that a small air gap is established between the rotor core 25 and the stator core 50. The air gap allows for relatively free rotation of the rotor 15 within the stator 20.

The motor 10 illustrated in FIG. 1 is a permanent magnet brushless motor. As such, the rotor 15 includes permanent magnets (not shown) that define two or more magnetic poles. The stator 20 includes windings that can be selectively energized to produce a varying magnetic field. The permanent magnets of the rotor 15 interact with the magnetic field of the stator 20 to produce rotor rotation. As one of ordinary skill will realize, the invention is well suited to many types of motors (e.g. induction motors), in addition to the permanent magnet brushless motors 10 illustrated herein. As such, the invention should not be limited to only these types of motors. Furthermore, one of ordinary skill will realize that the present invention can also be applied to many types of generators. Thus, while the figures and description refer to a brushless motor 10 and/or a rotor 15, other applications are possible.

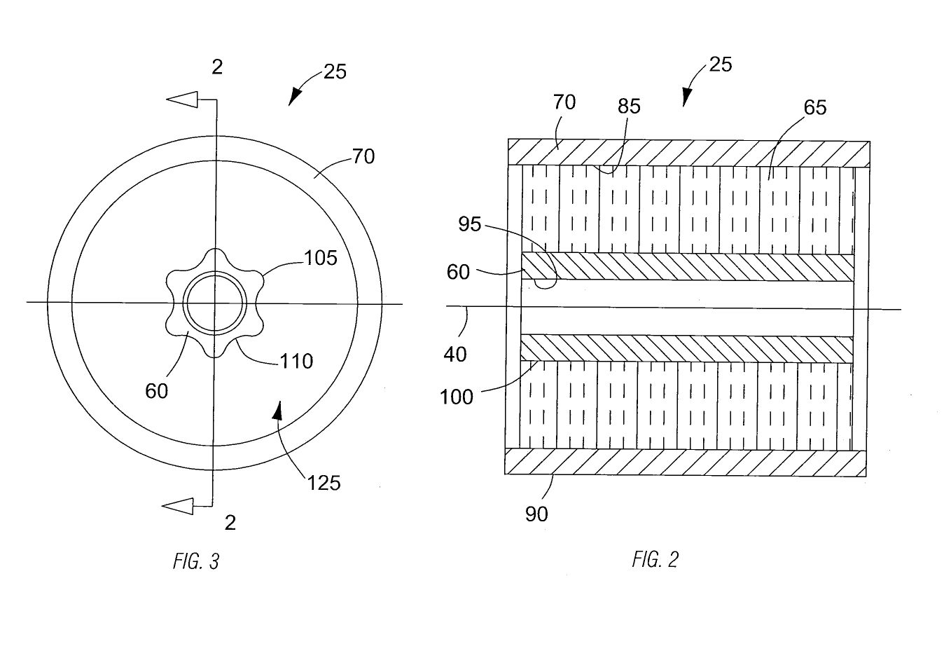

FIGS. 2 and 3 illustrate a rotor core 25 suitable for use with the motor 10 of FIG. 1. Specifically, FIG. 2 illustrates a rotor core 25 that includes a first or shaft sleeve 60, a damper portion 65, and a second or rotor sleeve 70. The rotor sleeve 70 is a substantially cylindrical tube having an inner surface 85 and an outer surface 90. The outer surface 90 is sized to receive permanent magnets, laminations, or rotor core pieces as required for the particular motor 10.

In the illustrated construction, the rotor sleeve 70 is relatively thick (i.e., greater than about 0.25 inches) such that no laminations or additional core material is required. Permanent magnets are simply glued or otherwise attached directly to the outer surface 90 of the rotor sleeve 70. In a preferred construction, the rotor sleeve 70 is formed using a powdered metal. However, many different manufacturing processes (e.g., casting forging, machining, etc.) can be employed so long as the rotor sleeve 70 includes sufficient ferrous material.

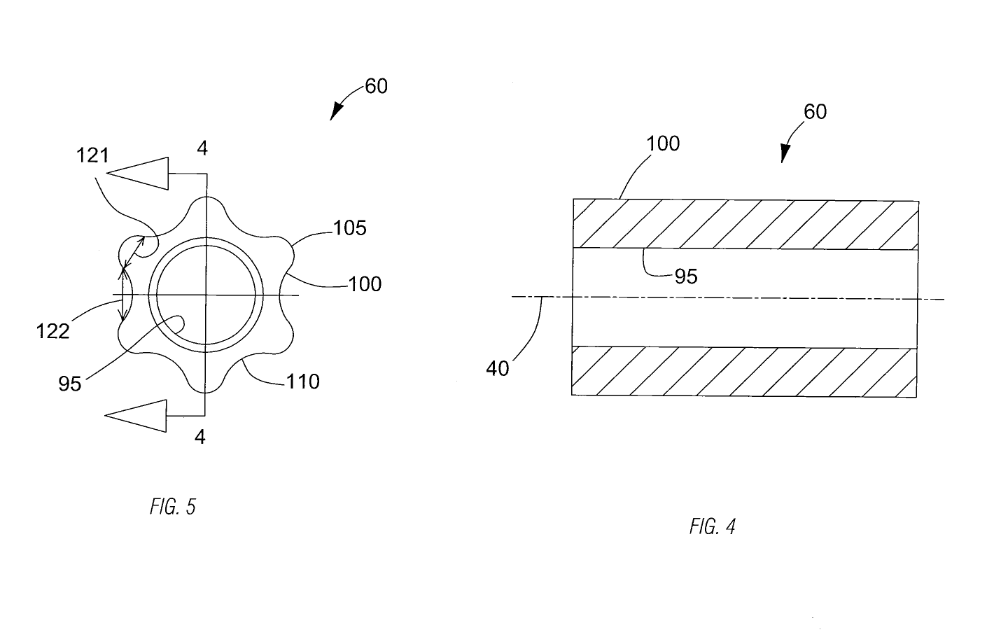

The shaft sleeve 60, illustrated in FIGS. 4 and 5, includes an inner surface 95 and an outer surface 100. The inner surface 95 is sized to closely fit over the shaft 30 of the rotor 15. In a preferred construction, a slight interference fit exists between the shaft 30 and the shaft sleeve 60 to inhibit relative rotation between the two components. In some constructions, one or both of the inner surface 95 and the outer surface of the shaft 30 may be roughened to increase the frictional engagement therebetween.

The outer surface 100 of the shaft sleeve 60 includes a plurality of peaks 105 and valleys 110 that extend the full length of the shaft sleeve 60. The peaks 105 and valleys 110 are best illustrated when viewed in a plane normal to the rotational axis (FIG. 3). In the illustrated construction, there are six peaks 105 and six valleys 110 with other constructions employing more or fewer peaks 105 and valleys 110. Each peak 105 is somewhat narrower than each of the valleys 110. In other words, each peak 105 defines an average peak width 121 and each valley 110 defines an average valley width 122 that is larger than the peak width 121. However, other constructions may include equal width peaks 105 and valleys 110 or peaks 105 that are wider than the valleys 110. The peaks 105 and valleys 110 are defined by a smooth curve that is substantially sinusoidal in nature. However, other constructions may include different shaped peaks such as triangular, square, trapezoidal, or still other shapes.

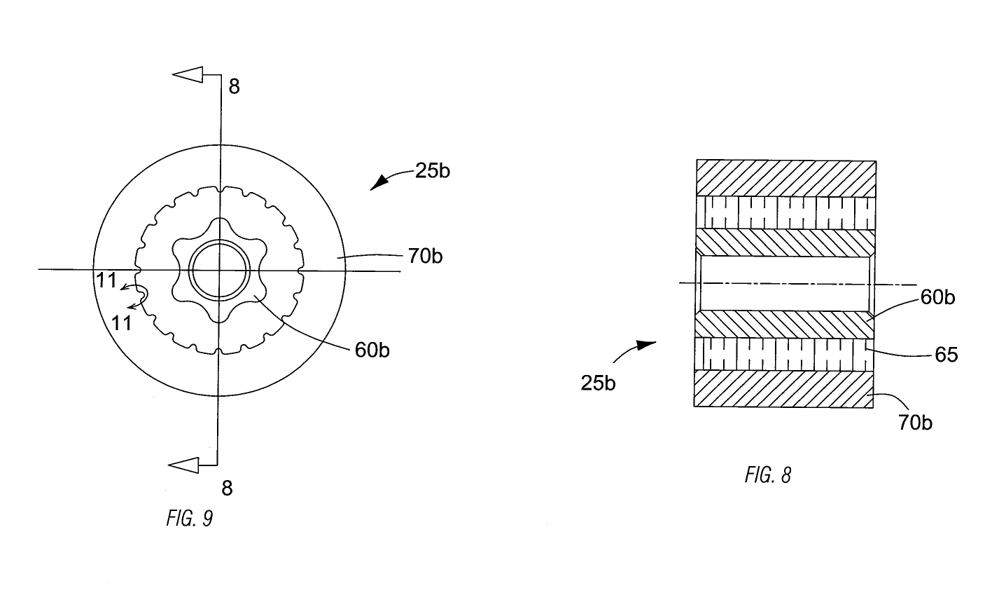

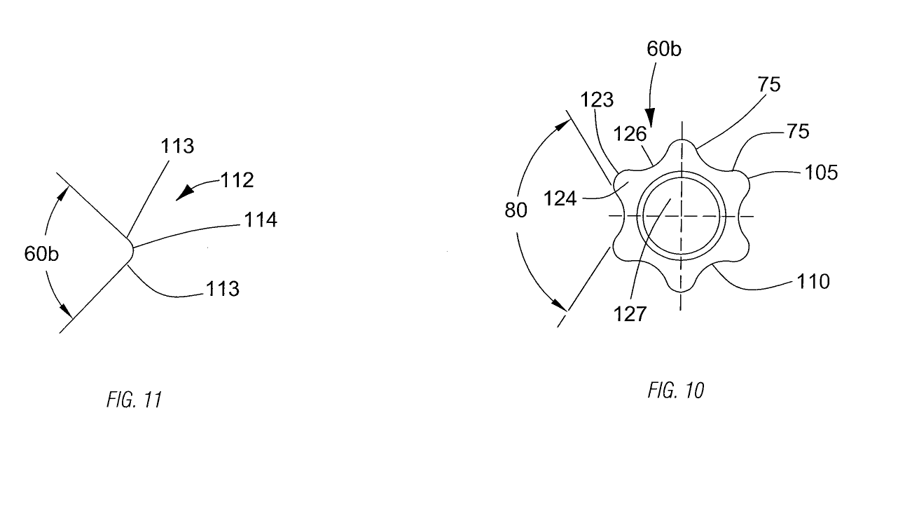

For example, FIGS. 8-10 illustrate another construction of a rotor core 25b that includes peaks 105 and valleys 110 wherein the peaks include substantially planar surfaces 75 that extend between the bottom of the valleys 110 and the top portion of the peaks 105. As shown in FIG. 10, adjacent surfaces 75 cooperate to define an angle 80 that is about 120 degrees, with other angles 80 also being possible. Thus, the peaks 105 include a curved apex 123 that defines a focal point 124 or focal area inward of the outer surface 100. The valleys 110 include a trough 126 that defines a focal point 127 or focal area inward of the outer surface 100. In some constructions, the trough 126 is substantially planar, thus locating the focal point on the outer surface 100, which for purposes of this description is inward of the outer surface 100.

In the illustrated constructions, the shaft sleeve 60 is manufactured from a powdered metal. However, other constructions may use other manufacturing processes (e.g., casting, forging, machining, etc.) to form the shaft sleeve 60. In preferred constructions, a ferrous material is employed with other materials also being suitable for use.

The rotor sleeve 70 and the shaft sleeve 60 cooperate to substantially define an annular space 125. In some constructions, annular end plates may be employed to completely enclose the annular space 125 if desired. Before proceeding, the term “annular” as used herein should not be limited to a space defined by a two extruded and spaced apart circles. Rather, any space defined by a first component that surrounds a second component is “annular.” Thus, irregular or non-circular inner or outer surfaces can define an annular space.

A resilient material is positioned between the shaft sleeve 60 and the rotor sleeve 70 in the annular space 125 to define the damper portion 65 and interconnect the shaft sleeve 60 and the rotor sleeve 70. The resilient material is chosen such that it provides a sufficiently rigid connection between the shaft sleeve 60 and the rotor sleeve 70 to allow for the transfer of torque, but still provides some vibration damping. In a preferred construction, a material having a durometer between about 47 and 57 is preferred. One suitable material is urethane or urethane rubber with other materials also being possible.

The peaks 105 and valleys 110 of the shaft sleeve 60 engage the resilient material and increase the connection therebetween. Specifically, rather than relying solely on a frictional connection between the shaft sleeve 60 and the damper portion 65, the peaks 105 and valleys 110 introduce some shear area that increases the force required to cause relative motion between the damper portion 65 and the shaft sleeve 60.

In some constructions, the inner surface 85 of the rotor sleeve 70 is roughened, knurled, or lobed to increase the strength of the connection between the damper portion 65 and the rotor sleeve 70. Generally, this is not required because the surface area between the damper portion 65 and the rotor sleeve 70 is significantly larger than the surface area between the shaft sleeve 60 and the damper portion 65. The larger surface area increases the total frictional force between the two components and generally makes non-cylindrical surfaces unnecessary.

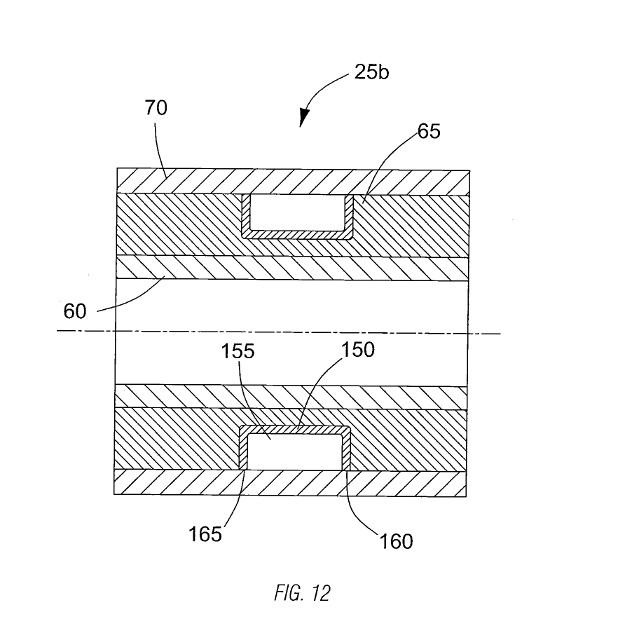

FIGS. 9 and 11 illustrate a rotor core 25b that includes peaks 112 formed on the inner surface 85 of the rotor sleeve 70b. The peaks 112 extend into the annular space 125 and provide additional shear area as well as additional surface area that engage the resilient material. The peaks 112 increase the amount of torque that can be transmitted between the rotor sleeve 70b and the damper portion 65 in comparison to the torque that can be transmitted without the peaks 112. The peaks 112, illustrated in FIG. 11 are substantially triangular or wedge-shaped with two substantially planar surfaces 113 and a slightly rounded top corner 114. The two planar surfaces 113 cooperate to define an angle 116 that is about 90 degrees with other angles also being possible. Of course other shapes, sizes, and quantities of peaks 112 can be varied as required by the particular application. For example, other constructions include square shaped peaks, semi-circular shaped peaks, and/or trapezoidal shaped peaks. The shape of the rotor core peaks and the shape of the rotor sleeve peaks can be varied as desired to assure an adequate bond and adequate sheer area between the rotor core and resilient material and the rotor sleeve and the resilient material. In one construction, the rotor core peaks and the rotor sleeve peaks resemble the splines of a spline shaft.

While the present construction includes permanent magnets that are attached directly to the outer surface 90 of the rotor sleeve 70, other constructions may include laminations or other core portions attached to the outer surface 90 of the rotor sleeve 70. The magnets then attach to the laminations or the other core portions.

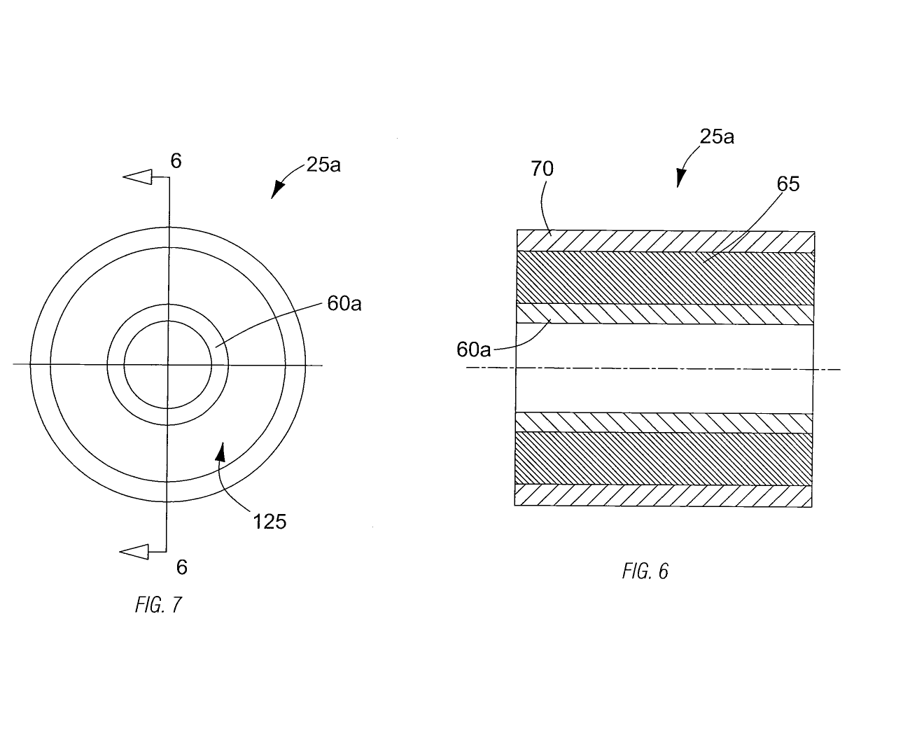

FIGS. 6 and 7 illustrate another rotor core 25a that includes a shaft sleeve 60a that is a substantially tubular component. In other words, the inner surface and the outer surface are circular when viewed in the plane normal to the rotational axis. While this construction will work in some applications, the construction illustrated in FIGS. 2-5 has several advantages. For example, the construction of FIGS. 2-5 can operate at higher torque levels than the construction of FIGS. 6-7.

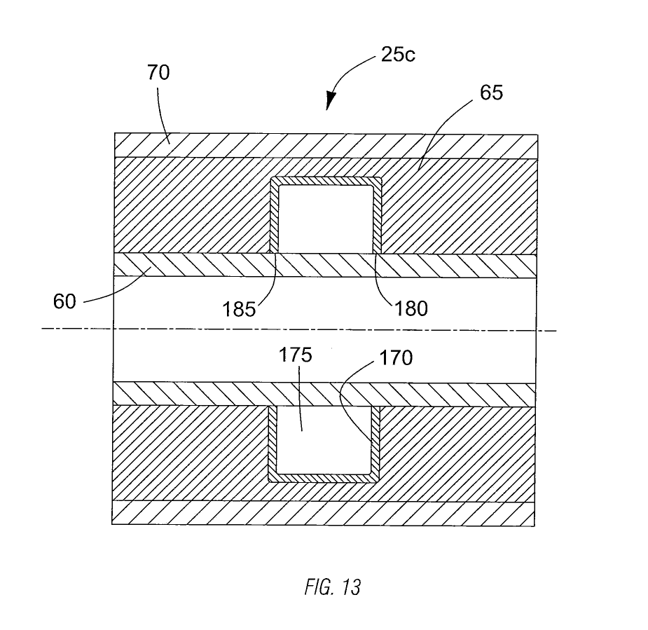

FIG. 12 illustrates another rotor core 25b that includes a spacer 150 positioned adjacent the inner surface of the rotor sleeve 70. The spacer 150 cooperates with the rotor sleeve 70 to define a space 155 that is not filled with resilient material. The spacer 150 includes two bore surfaces 160, 165 that contact the rotor sleeve 70 and form a substantial seal that inhibits entry of the resilient material into the space 155. Thus, the spacer 150 reduces the quantity of resilient material disposed between the shaft sleeve 60 and the rotor sleeve 70. In a preferred arrangement, at least one inch of resilient material is used on either end of the spacer 150 to define the damper portion 65 and assure an adequate connection between the rotor sleeve 70 and the shaft sleeve 60.

FIG. 13 illustrates an alternative construction similar to that of FIG. 12. The rotor core 25c of FIG. 13 includes a spacer 170 that cooperates with the shaft sleeve 60 rather than the rotor sleeve 70 to define a space 175. In this arrangement, the spacer 170 includes two bore surfaces 180, 185 that closely match the shape of the shaft sleeve 60 to define a substantial seal therebetween. Thus, the spacer 170 of FIG. 13 also reduces the quantity of resilient material needed to define the damper portion 65 and to fill the space between the shaft sleeve 60 and the rotor sleeve 70.

In still other constructions, a first washer and a second washer are inserted into the space between the shaft sleeve 60 and the rotor sleeve 70. The washers include an inner surface that contacts the shaft sleeve 60 and an outer surface that contacts the rotor sleeve 70. Thus, when the washers are spaced apart from one another, they define a space that does not fill with resilient material. In this construction, the space between the shaft sleeve 60 and the rotor sleeve 70 is divided into two separate spaces that are filled with resilient material to define the damper portion 65.

To assembly a rotor core 25, 25a as discussed herein, the rotor sleeve 70 and the shaft sleeve 60 are first manufactured. As discussed, preferred constructions employ powdered metal to manufacture these components, as such typical powdered metal manufacturing techniques are generally employed (e.g., compaction, sintering, machining, and the like).

In some constructions, the rotor sleeve 70 is coupled to the shaft 30 before further assembly. In other constructions, the rotor core 25 is further assembled before the shaft 30 is coupled to the shaft sleeve 60. The shaft sleeve 60 and the rotor sleeve 70 are positioned within a mold and the resilient material is added. In one construction, the resilient material is pored into the annular space 125 and is allowed to set to complete the damper portion 65. In another construction, the shaft sleeve 60 and the rotor sleeve are positioned within a mold to enclose the annular space 125 and the resilient material is injected into the space 125 to complete the damper portion 65. Using either process produces a rotor core 25 that includes the rotor sleeve 70 and the shaft sleeve 60 bonded to one another by the damper portion 65.

In constructions in which the shaft 30 is added last, the core 25 is pressed onto, or shrunk fit onto the shaft 30. The magnets are then attached to the rotor sleeve 70 using any suitable process (e.g., welding, soldering, brazing, glues, adhesives, fasteners, etc.).

Thus, the invention provides, among other things, a new and useful rotor core 25 for a motor 10. More particularly, the invention provides a new and useful rotor core 25 that includes a damper portion 65 that reduces undesirable motor noise.

What is claimed is:

1. A rotor for a motor having a rotor core length, the rotor comprising:
a shaft including a cylindrical portion;
a shaft sleeve having a cylindrical opening, the shaft sleeve coupled to the shaft such that the cylindrical opening and the cylindrical portion define an interference fit;
a rotor sleeve extending the rotor core length and including a cylindrical outer surface and an inner surface, the inner surface spaced a non-zero distance from the shaft sleeve to define a space; and
a resilient material disposed within the space and bonded to the shaft sleeve and the rotor sleeve.

2. The rotor of claim 1, wherein the shaft defines a rotational axis and the shaft sleeve defines an exterior surface, and wherein the cylindrical opening and the exterior surface define circular cross sections in a plane normal to the rotational axis.

3. The rotor of claim 2, wherein the outer surface and the inner surface of the rotor sleeve define circular cross sections in the plane normal to the rotational axis.

4. The rotor of claim 1, further comprising a plurality of magnets fixedly attached to the cylindrical outer surface.

5. The rotor of claim 1, wherein the shaft sleeve includes an exterior surface including a plurality of peaks having a first width and a plurality of valleys having a second width, the second width being greater than the first width.

6. The rotor of claim 1, wherein the shaft sleeve includes an exterior surface that includes a plurality of peaks that include a curved apex having a focal point inward of the outer surface, and a plurality of valleys that include a trough having a focal point inward of the exterior surface.

7. The rotor of claim 1, wherein the inner surface of the rotor sleeve includes a plurality of substantially wedge-shaped peaks that extend toward the shaft.

8. A rotor for a motor having a rotor core length, the rotor comprising:
a shaft including a cylindrical portion;
a shaft sleeve having a cylindrical opening and an exterior surface that includes a plurality of peaks and valleys, the shaft sleeve coupled to the cylindrical portion;
a rotor sleeve having a cylindrical outer surface and an inner surface, the inner surface spaced a non-zero distance from the shaft sleeve to define a space, the rotor sleeve extending the core length; and
a resilient material disposed within the space and bonded to the shaft sleeve and the rotor sleeve.

9. The rotor of claim 8, wherein the cylindrical portion and the cylindrical opening cooperate to define an interference fit.

10. The rotor of claim 8, wherein the shaft defines a rotational axis, and wherein the cylindrical opening defines a circular cross section in a plane normal to the axis.

11. The rotor of claim 10, wherein the outer surface and the inner surface of the rotor sleeve define circular cross sections in the plane normal to the axis.

12. The rotor of claim 8, further comprising a plurality of magnets fixedly attached to the cylindrical outer surface.

13. The rotor of claim 8, wherein the peaks define a first width and the valleys define a second width, the second width being greater than the first width.

14. The rotor of claim 8, wherein the peaks include a curved apex having a focal point inward of the outer surface, and wherein the valleys include a trough having a focal point inward of the exterior surface.

15. The rotor of claim 8, wherein the inner surface of the rotor sleeve includes a plurality of substantially wedge-shaped peaks that extend toward the shaft.

16. A rotor for a motor having a rotor core length, the rotor comprising:
a shaft including a cylindrical portion that defines a rotational axis;
a shaft sleeve coupled to the shaft and having a first inner surface and a first outer surface, the first inner surface having a circular cross section in a plane normal to the rotational axis and the first outer surface having a non-circular cross section in the plane;
a rotor sleeve extending the rotor core length and including a second outer surface and a second inner surface, the second outer surface having a circular cross section in the plane and the second inner surface having a non-circular cross section in the plane, the inner surface spaced a non-zero distance from the shaft sleeve to define a space; and
a resilient material disposed within the space and bonded to the first outer surface and the second inner surface.

17. The rotor of claim 16, wherein the first inner surface and the cylindrical portion cooperate to define an interference fit.

18. The rotor of claim 16, further comprising a plurality of magnets fixedly attached to the second outer surface.

19. The rotor of claim 16, wherein the first outer surface includes a plurality of peaks that define a first width and a plurality of valleys that define a second width, the second width being greater than the first width.

20. The rotor of claim 16, wherein the first outer surface includes a plurality of peaks that include a curved apex having a focal point inward of the outer surface, and a plurality of valleys that include a trough having a focal point inward of the trough.

21. The rotor of claim 16, wherein the second inner surface includes a plurality of substantially wedge-shaped peaks that extend toward the shaft.
